(19) United States
(12) Patent Application Publication
(10) Pub. No.: US 2009/0198739 A1
(43) Pub. Date: Aug. 6, 2009

(54) FILE MANAGEMENT METHOD AND SYSTEM FOR IMAGE CAPTURING DEVICE

(75) Inventors: WEI-JEN WANG, Tu-Cheng (TW); SHIH-PAO CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/166,334

(22) Filed: Jul. 2, 2008

(30) Foreign Application Priority Data
Feb. 1, 2008 (CN) 200810300305.9

(51) Int. Cl. G06F 17/30

(52) U.S. Cl. 707/200; 707/E17.005

(57) ABSTRACT

A file management system for managing a number of files stored in an image capturing device includes a classifying unit, a calculating unit, a selecting unit, and a processing unit. The classifying unit is configured for classifying the files in a storage unit of the image capturing device into different clusters according to the file suffixes. The measuring unit is configured for measuring how much memory is currently occupied by the files in the storage unit, size of each cluster and percentage of total available memory occupied by each of the clusters to display the percentages on a display panel. The selecting unit is configured for selecting a desired cluster in response to user input at the input unit. The processing unit is configured for accessing the measurements of the selected cluster(s) and generating a view revealing the measurements on a display panel.

### BACKGROUND

1. Field of the Invention

The present invention relates to file management methods and systems and, particularly, to a file management method and system for an image capturing device.

2. Description of the Related Art

Current file management systems installed in image capturing devices, such as digital still cameras, only allow checking how much free space remains. The information is not enough for users to properly manage files stored in the image capturing device.

Therefore, it is desirable to provide a file management system and method for an image capturing device, which can overcome the above mentioned problem.

### SUMMARY

A file management system for managing a number of files stored in an image capturing device includes a classifying unit, a calculating unit, a selecting unit, and a processing unit. The classifying unit is configured for classifying the files in a storage unit of the image capturing device into different clusters according to the file suffixes. The measuring unit is configured for measuring how much memory is currently occupied by the files in the storage unit, size of each cluster and percentage of total available memory occupied by each of the clusters to display the percentages on a display panel. The selecting unit is configured for selecting a desired cluster in response to user input at the input unit. The processing unit is configured for accessing the measurements of the selected cluster(s) and generating a view revealing the measurements on a display panel.

### BRIEF DESCRIPTION OF THE DRAWINGS

FIG. 1 is a block diagram of a file management system for an image capturing device including a display panel, according to a first exemplary embodiment.

FIG. 2 is an example of how information may be displayed on the display panel of FIG. 1.

FIG. 3 is another example of how information may be displayed on the display panel of FIG. 1.

FIG. 4 is a flowchart of a file management method for the image capturing device, according to a second exemplary embodiment.

### DETAILED DESCRIPTION

Embodiments of the present file management system and method for an image capturing device will be described in detail below with reference to the accompanying drawings.

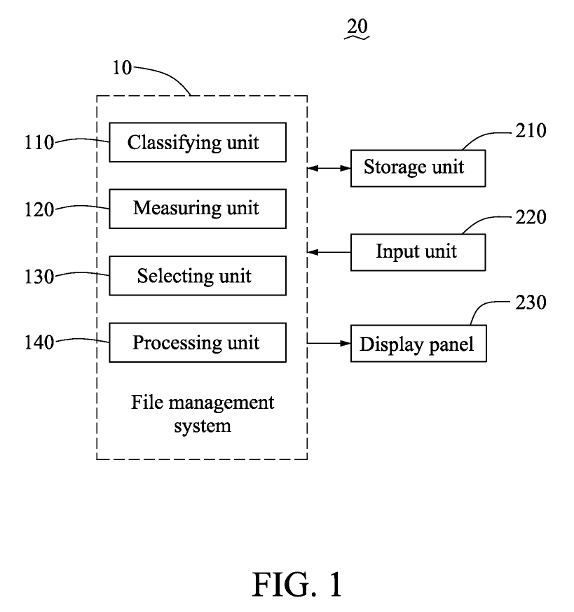

Referring to FIG. 1, a file management system 10 is configured for managing files stored in an image-capturing device 20. In this embodiment, the image capturing device 20 is a camera, but it should be understood that the application of the file management system 10 is not limited by this embodiment, and can be any other image capturing device, such as a cellular phone having a camera module.

The image capturing device 20 includes a storage unit 210, an input unit 220, and a display panel 230. The storage unit 210, such as a memory stick or a SECURE DIGITAL (SD) memory card, is configured for storing the files. These files can be various media files including photos, videos, voices, etc., along with any metadata such as file name, file size, quality, suffix, and timestamp. For example, a photo may be a super fine quality image (2272*1704 pixels), a fine quality image (1600*2000 pixels), a normal quality image (1024*768 pixels), or a basic quality image (640*480 pixels), and suffixed as RAW, JPEG, or TIFF. In addition, a video may be suffixed as AVI or DVI; a voice can be suffixed like MP3 or WMA; and other types of files may include DOC or TXT suffix. All of this information can be stored as metadata of the files. The input unit 220 such as a touch screen is configured for receiving user input. The display panel 230, such as a liquid crystal display (LCD) panel, is configured for displaying various views for users.

The file management system 10 includes a classifying unit 110, a measuring unit 120, a selecting unit 130, and a processing unit 140.

The classifying unit 110 is configured for classifying the files stored in the storage unit 210 according to their suffixes into different clusters, such as “photo cluster”, “video cluster”, “voice cluster”, and “other cluster”.

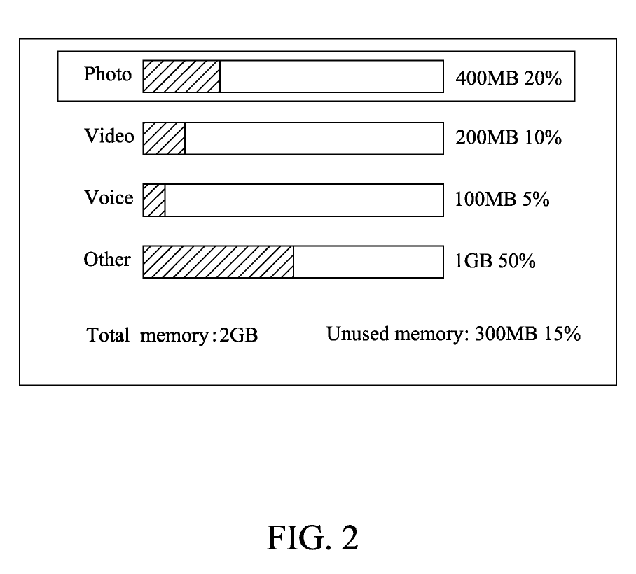

Further referring to FIG. 2, the measuring unit 120 is configured for measuring how much memory is currently occupied by files in the storage unit 210, size of each cluster, and percentage of total available memory occupied by each of the cluster to display the percentages on the display panel 230. For example, the measuring unit 120 indicates: a total of 2 GB of memory is available for files in the storage unit, and currently the photo cluster occupies 400 MB, the video cluster occupies 200 MB, the voice cluster occupies 100 MB, the other cluster occupies 1 GB, and 300 MB is not in use. Therefore, the photo cluster occupies 20% of the available memory; the video cluster occupies 10%; the voice cluster 5%; and the other cluster occupies 50%; leaving 15% of the available memory 2 GB unused.

The selecting unit 130 is configured for selecting a desired cluster in response to user input at the input unit 220. In this embodiment, the photo cluster is selected.

The processing unit 140 is configured for accessing the measurements of the selected cluster(s) and generating a view revealing the measurements on the display panel 230.

Referring again to FIG. 2, an example of how information may be displayed on the display panel 230, shows a bar graph being used to indicate percentage of memory occupied by each of the clusters. Each bar is labeled with the corresponding cluster name, the cluster size, and percentage of memory used as well as indicating graphically the percentage used. Moreover, the total memory of the storage unit 210, and the percentage of the total capacity of the storage unit 210 that is not in use are also shown.

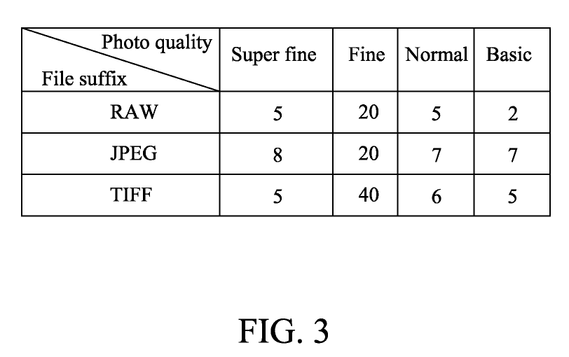

Referring to FIG. 3, in another example of how information may be displayed on the display panel 230, a table showing a number of the files according to file suffixes and photo quality for the photo cluster of FIG. 2 is shown. In this embodiment, the files are categorized by their suffixes and photo quality. For example, five files have “super fine” photo quality and “RAW” suffix.

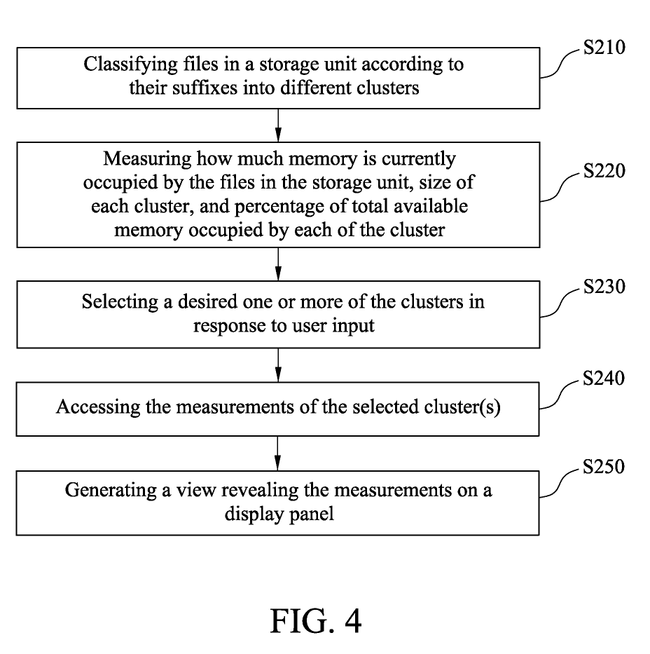

Referring to FIG. 4, a method for managing files in the image-capturing device 20 includes the steps S210 through S250.

S210: Classifying files in the storage unit 210 according to their suffixes into different clusters.

S220: Measuring how much memory is currently occupied by the files in the storage unit, size of each cluster, and percentage of total available memory occupied by each of the cluster to display the percentages on the display panel 230.

S230: Selecting a desired one or more of the clusters in response to user input at the input unit 220.

S240: Accessing the measurements of the selected cluster(s).

S250: Generating a view revealing the measurements on the display panel 230.

Compared with the related art, the storage management system classifies files according to their file suffixes and reveals percentage of memory occupied by groups of related files, i.e., clusters, which is convenient for users.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A file management system for managing files stored in an image capturing device, comprising:
a classifying unit configured for classifying the files in a storage unit of the image capturing device into different clusters according to file suffixes;
a measuring unit configured for measuring how much memory is occupied by the files in the storage unit, size of each cluster, and percentage of total available memory occupied by each of the cluster;
a selecting unit configured for selecting a desired cluster in response to user input; and
a processing unit configured for accessing the measurements of the selected cluster and generating a view revealing the measurement on a display panel.

2. The file management system as claimed in claim 1, wherein the storage unit for storing the files is a memory stick.

3. The file management system as claimed in claim 1, wherein the storage unit for storing the files is a secure digital memory card.

4. The file management system as claimed in claim 1, wherein the input unit is a touch screen.

5. The file management system as claimed in claim 1, wherein the display panel is a liquid crystal display panel.

6. The file management system as claimed in claim 1, wherein the different clusters are entitled “photo cluster”, “video cluster”, “voice cluster”, “other cluster”, classified according to the file suffixes.

7. The file management system as claimed in claim 6, wherein each of the file suffixes of the photo clusters is one selected from the group consisting of RAW, TIFF and JPEG.

8. An image capturing device, comprising:
a storage unit for storing files;
a file managing system configured for classifying the files into different clusters according to file suffixes, measuring how much memory is occupied by the files in the storage unit, size of each cluster, and accessing the measurements of the selected cluster;
an input unit for selecting a desired cluster in response to user input; and
a display panel for displaying a view revealing the measurements.

9. The image capturing device as claimed in claim 8, wherein the file managing system comprises:
a classifying unit configured for classifying the files from the storage unit into the different clusters according to the file suffixes;
a measuring unit configured for measuring how much memory is occupied by the files in the storage unit, size of each cluster, and percentage of total available memory occupied by each of the cluster;
a selecting unit configured for selecting the desired cluster in response to input unit; and
a processing unit configured for accessing the measurements of the selected cluster and

10. The image capturing device as claimed in claim 8, wherein the storage unit for storing the files is a memory stick.

11. The image capturing device as claimed in claim 8, wherein the storage unit for storing the files is a secure digital memory card.

12. The image capturing device as claimed in claim 8, wherein the input unit is a touch screen.

13. The image capturing device as claimed in claim 8, wherein the display panel is a liquid crystal display panel.

14. The image capturing device as claimed in claim 8, wherein the different clusters are entitled “photo cluster”, “video cluster”, “voice cluster”, “other cluster”, classified according to the file suffixes.

15. The file management system as claimed in claim 14, wherein each of the suffixes of the photo cluster is one selected from the group consisting of RAW, TIFF and JPEG.

16. A method for managing files of an image-capturing device, comprising:
classifying the files in a storage unit of the image-capturing device according to the file suffixes into different clusters;
measuring how much memory is occupied by the files in the storage unit, size of each cluster, and percentage of total available memory occupied by each of the cluster;
selecting a desired cluster in response to user input;
accessing the measurements of the selected cluster; and
generating a view revealing the measurements.
